(19) United States
(12) Patent Application Publication
(10) Pub. No.: US 2013/0015931 A1
(43) Pub. Date: Jan. 17, 2013

(54) TUNABLE STIFFNESS ACTUATOR

(71) Applicants: Shivaram AC, Bangalore (IN); Vidyashankar R. Buravalla, Bangalore (IN)

(72) Inventors: Shivaram AC, Bangalore (IN); Vidyashankar R. Buravalla, Bangalore (IN)

(73) Assignee: GM GLOBAL TECHNOLOGY OPERATIONS LLC, Detroit, MI (US)

(21) Appl. No.: 13/454,566

(22) Filed: Apr. 24, 2012

(30) Foreign Application Priority Data
Jul. 11, 2011 (IN) 2359/CHE/2011

(51) Int. Cl. H01F 7/08

(52) U.S. Cl. 335/229

(57) ABSTRACT

An actuator adaptable for tunable stiffness control is provided, including a stiffness element including a smart material, and a magnetically actuated biasing element. The biasing element is configured to provide a non-linear or variable bias force on the stiffness element. The smart material may be a shape memory alloy, and the biasing element may be configured to include a permanent magnet, an electromagnet, a magnetic shape memory alloy, or a combination of these. The stiffness element and the biasing element of the actuator may be configured in parallel with each other, or may be configured in series with each other. The bias force may be provided in response to an input defined by one or more of fatigue, functional degradation, aging, shakedown, elongation, and operating environment of the stiffness element of the actuator, or defined by an operating characteristic of the actuator or a device controlled by the actuator.

### CROSS-REFERENCE TO RELATED APPLICATIONS

This application claims the benefit of India Provisional Patent Application No. 2359/CHE/2011, filed Jul. 11, 2011, which is hereby incorporated by reference in its entirety.

### TECHNICAL FIELD

The present invention relates to stiffness control using smart actuators.

### BACKGROUND

Smart actuators and smart actuated devices including a shape memory alloy (SMA) element may typically be configured to use a mechanical spring with a predetermined, e.g., constant, stiffness for biasing the SMA element, for example, to assist with the return of the SMA stiffness element from an actuated shape to a non-actuated shape. Using a predetermined stiffness to bias the SMA element can lead to sub-optimal performance of the actuated device in the presence of off-design working conditions such as changes in operating environment and deterioration of components interfacing with the smart actuator. In large design spaces, a higher bias stress may be required under some operating conditions to avoid false actuation, which may result in a sub-optimized performance under nominal conditions, or reduced useful life of the SMA element caused by the higher bias stress.

Performance of thermally activated SMA elements may be influenced by changes in ambient conditions, and/or deterioration or degradation of the SMA element due to repeated use or in-service loads which may be designed or incidental loads, repeated actuations at high temperatures or high loads, or other factors affecting stiffness element performance, durability and reliability, such as aging, fatigue, shakedown, and/or elongation of the stiffness element material after repeated actuation. As the performance of the SMA element and/or performance of the mechanical spring changes or degrades, the performance of the smart actuator or device including the SMA element and mechanical spring may become decreasingly effective.

### SUMMARY

It may be desirable to configure a shape memory alloy (SMA) device or actuator with a magneto-spring or other magnetically actuated biasing element, such as a magnetic SMA (MSMA) element, to provide a tunable biasing element which can accommodate changes in the performance of the SMA device due to changes in ambient or operating conditions, or other changes including aging and deterioration of the SMA element, to provide an actuator with tunable stiffness characteristics. By using a magnetically actuated biasing element which can be configured to provide a variable biasing force on the SMA stiffness element, the biasing force can be adjusted to operating conditions and to avoid overstressing of the SMA element, thus extending the useful life of the SMA element, and to optimize actuation performance of the SMA actuator over a range of operating conditions. One or more magnetic biasing elements may be placed in series, in parallel, or in a combination of in series and in parallel, with the SMA element, to provide a bias force on the SMA element, wherein the bias force may be a tunable or variable bias force.

An actuator adaptable for tunable stiffness control is provided, the actuator including a stiffness element including a smart material, and a biasing element configured to be magnetically actuated. The biasing element is magnetically actuated to provide a bias force on the stiffness element. The smart material may be a shape memory alloy (SMA), which may be configured, for example, as one of an SMA wire or SMA spring. By way of non-limiting examples, the stiffness element and the biasing element of the actuator may be configured in parallel with each other, or may be configured in series with each other. The bias force provided by the biasing element may be a non-linear bias force. The actuator may be configured to provide a variable bias force in response to an input.

The biasing element may be configured to include a permanent magnet, an electromagnet, a magnetic smart material alloy (MSMA), or a combination of these. The input may be configured as an electrical current, which may activate a biasing member, such as an electromagnet, to provide a variable bias force using the biasing element. The input may be defined by one or more of fatigue, functional degradation, aging, the output of the actuator, the output of a device actuated by the actuator, or the output of a system including the actuator. The input may be defined by an operating characteristic or the operating environment, for example, the temperature or humidity of actuator environment, monitored, for example, by the controller.

The actuator may include a plurality of stiffness elements, wherein at least one of the plurality of stiffness elements includes a smart material, and a plurality of biasing elements, wherein at least one of the plurality of the biasing elements is magnetically actuated. Each of the plurality of biasing elements may be actuable in series with at least one of the plurality of stiffness elements, actuable in parallel with at least one of the plurality of stiffness elements, or actuable in a combination of parallel and series with each other and one or more of the plurality of stiffness elements, such that at least one of the plurality of biasing elements may be manipulated to provide a bias force, which may be a variable or nonlinear bias force, on at least one of the plurality of stiffness elements.

A method for providing tunable stiffness control includes configuring an actuator to provide a stiffness control output. The actuator includes a stiffness element including an actuable smart material and a biasing element configured to be magnetically actuated to provide a variable bias force. The method further includes actuating the smart material element and selectively actuating the biasing element to provide the actuator stiffness control output.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an actuator including a smart stiffness element and a magnetic biasing element configured in parallel;

FIG. 2 is a schematic illustration of an actuator including a smart stiffness element and a magnetic biasing element configured in parallel;

FIG. 3 is a schematic illustration of an actuator including a smart stiffness element and a magnetic biasing element configured in parallel configured in series;

FIG. 4 is a schematic illustration of an actuator including a smart stiffness element and a magnetic biasing element configured in parallel and in series;

FIG. 5 is a schematic illustration of an actuator including a smart stiffness element and a magnetic biasing element providing a constant bias force and configured in parallel;

FIG. 6 is a schematic illustration of an actuator including a smart stiffness element and a magnetic biasing element providing a tunable bias force and configured in parallel; and

FIG. 7 is a schematic illustration of an actuator including a smart stiffness element and a magnetic biasing element configured in parallel.

### DETAILED DESCRIPTION

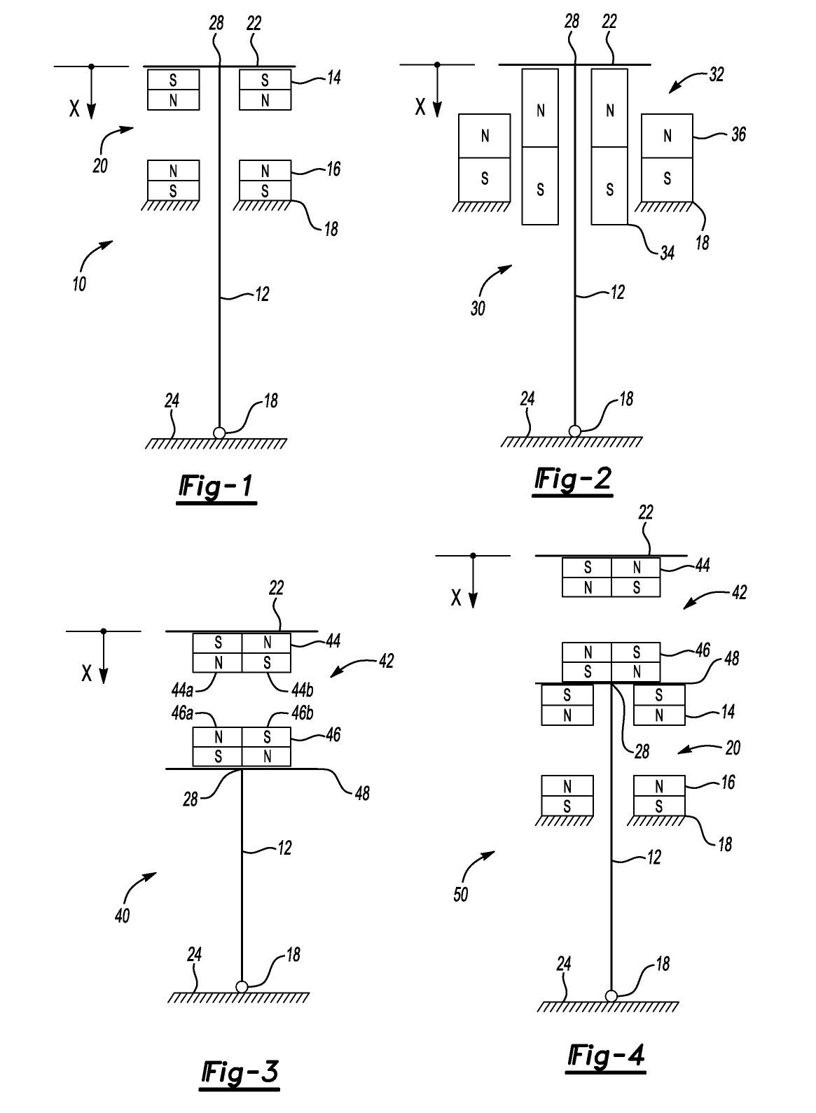

Referring to the drawings wherein like reference numbers represent like components throughout the several figures, the elements shown in FIGS. 1-7 are not to scale or proportion. Accordingly, the particular representations, dimensions and applications provided in the drawings presented herein are not to be considered limiting.

FIG. 1 is a schematic illustration of an actuator generally indicated at 10, and adaptable for tunable stiffness control. The actuator 10 includes a stiffness element 12 and a magnetic biasing element generally indicated at 20. The stiffness element 12 may include a smart material. The biasing element 20 may be configured to be magnetically actuated, to provide a bias force on the stiffness element 12. By way of non-limiting example, the stiffness element and the biasing element may be configured in parallel with each other, as shown in FIGS. 1 and 2. In FIG. 1, the stiffness element 12 is shown in parallel with the biasing element 20 comprising the actuator 10. In FIG. 2, the stiffness element 12 is shown in parallel with another biasing element 32 comprising an actuator 30. The stiffness element 12 may be configured in series with a biasing element 42 to comprise an actuator 40, as shown in the non-limiting example of FIG. 3. FIG. 4 shows another configuration for an actuator 50, wherein the actuator comprises a stiffness element 12 in parallel with a biasing element 20, and the combination of these elements 12, 20 are configured in series with a second biasing element 42. Other configurations of actuators comprising one or more stiffness elements and one or more biasing elements are possible, wherein the one or more stiffness elements and/or the one or more biasing elements are configured in series, in parallel, and/or in a combination thereof with each other to comprise an actuator adaptable for stiffness control. The bias force provided by the biasing element may be a non-linear bias force. The actuator may be configured to provide a variable bias force on the stiffness element in response to an input.

The stiffness element 12 may include a smart material such as a shape memory alloy (SMA), which may be configured, for example, as one of an SMA wire or SMA spring, and may be referred to herein as an SMA stiffness element, an SMA element, or a smart stiffness element. The SMA stiffness element 12 may be formed, in a non-limiting example, by a wire of shape memory alloy in a predetermined first shape (not shown), which may be, for example, a shrunk or contracted shape which is memorized by the SMA wire at a predetermined high temperature, e.g., its transformation temperature. The first shape may also be referred to herein as the austenitic shape, e.g., the shape which is memorized by the SMA element when the SMA is in a high temperature, or austenitic, state. The SMA element 12 is transformed (formed) by application of a shaping force at a lower temperature, e.g., a temperature below the transformation temperature, to a second shape and typically retains this second shape until heated by temperature or an applied current above the transformation temperature, whereby the SMA element 12 above the transformation temperature transforms from the second shape into its predetermined first, or austenitic, shape. The second shape may also be referred to herein as the martensitic shape, e.g., the shape which is memorized by the SMA element when the SMA is shaped by force while at a lower temperature, e.g., while the SMA is in a martensitic state. Upon cooling below the transformation temperature, the SMA element 12 then converts back into its second (martensitic) shape from its first (austenitic) shape.

The SMA element 12 can therefore be configured for use as a stiffness element in an actuator, such as actuators 10, 30, 40, 50, 60, 70, 80 shown in FIGS. 1-7, respectively, by manipulating the temperature of the SMA element 12 above and below a transformation temperature defined by the SMA material to cause a change in the shape of the SMA element which can be used to apply a force to/against an actuated member (not shown) in operative communication with an output interface 22. In the non-limiting examples shown in FIGS. 1-7, the stiffness element 12 may be operatively connected at a first connection 18 and at a second connection 28. The first connection 18 may be referred to as an input connection, which may be configured to provide input to activate the stiffness element 12 and/or a biasing element. The second connection 28 may be referred to as an output connection. The second connection may be in operative communication with the output interface 22, which may also be referred to as a second interface.

The stiffness element 12 may be selectively activated to apply a force, which may be a compressive or tensile force, in or opposing a direction shown by the arrow identified as X in FIG. 1, respectively, against the second or output interface 22. The output interface 22 and/or output connection 28 of actuator 10 may be in operative communication with or operatively connected to the actuable device or actuable member (not shown). An actuator 10 configured in this manner may be used, for example, to actuate an actual member, to engage/disengage the actuated member from another member, and/or to displace an actuated member in or opposing a direction X.

Referring again to FIG. 1, and using actuator 10 as a representative actuator, the stiffness element 12 may include a first interface 24, which may be, for example, a mounting surface or interface for operatively connecting the actuator 12 to an interfacing component or device, which may be an actuating component such as a controller, sensor, or switch. The first interface 24 may also be referred to as the input interface. The stiffness element 12 may be in operative communication or operatively connected through a first connection interface 18 to an actuating source (not shown). The first connection interface 18 may also be referred to as a first connection, or input connection. The actuating source may be configured, for example, as an electrical circuit, and the input connection 18 may be configured to operatively connect to the electrical circuit, through which an electrical current may be inputted or provided to the stiffness element 12 such that the stiffness element 12 is actuable by elevating the temperature of the SMA in the stiffness element 12 through resistance heating. In a non-limiting example, the stiffness element 12 may be operatively connected through input connection 18 and/or input interface 24 to one or more sensors or switches (not shown), or to a controller (not shown) which may be responsive to at least one sensor, where the at least one sensor is sensing an operating characteristic of one or more of the actuator 10, the stiffness element 12, a device actuated by the actuator 10, and/or a system which may include the actuator 10, and where the at least one sensor is providing a signal to the stiffness element 12, switch or controller in response to changes in the operating characteristic or characteristics being sensed.

The actuating source may be a switch and a power supply (not shown) operatively connected via input connection 18 to the stiffness element 12, such that when the switch is closed, an electrical current is flowed from the power supply to the stiffness element 12 and heat is generated by a resistance of the SMA wire of the stiffness element 12, increasing the temperature of the wire sufficiently such that the stiffness element 12 is activated and transforms from its martensitic shape to its austenitic shape, e.g., from its second shape to its first shrunk or predetermined shape, providing a tensile force in the direction X on the output connection 28 and/or the output interface 22. When the switch is turned off or opened to shut off or cease the supply of electrical current to the SMA element 12, the SMA element 12 is deactivated such that it cools and transforms to its second shape, thereby extending in length and in so doing, providing a compressive force opposing direction X from the actuator 10 against the output connection 28 and/or the output interface 22. It would be understood that other methods of thermally actuating the stiffness element 12 may be employed.

Other configurations of actuators including an SMA element 12 are shown in FIGS. 2-7. In each of the respective actuators 30, 40, 50, 60, 70, 80 shown by way of non-limiting example in FIGS. 2-7, respectively, the SMA element 12 is shown operatively attached at one end to an input connection 18 and/or input interface 24, and operatively attached at another end to an output connection 28 and/or output interface 22. It would be understood that the actuators 30, 40, 50, 60, 70, 80 each including an SMA element 12 may be actuated by an input from an actuating source to provide an actuator output, which may be a stiffness control output, to an actuable device as discussed previously for actuator 10 shown in FIG. 1.

Referring again to FIG. 1, in a non-limiting example the actuator 10 further includes a biasing element 20. The biasing element 20 may be configured to include one or more of a permanent magnet, an electromagnet, a magnetic shape memory alloy (MSMA), or another magnetically actuable member, such that the biasing element 20 is configured to be magnetically actuable. The biasing element 20 may be magnetically actuated by any means suitable to the magnetic member or members comprising the biasing element 20.

In the non-limiting example shown in FIG. 1, the biasing element 20 is comprised of the first biasing member 14 and a second biasing member 16, wherein at least one of the members 14, 16 is a magnetically actuable member. One of the biasing members 14, 16 may be configured in operative communication with the output interface 22, such that the biasing member is in operative communication with the stiffness element 12. The other of the biasing members 14, 16 may be in operative communication or operatively attached to a support interface 18, such that the relative movement between the first and second members 14, 16, for example, in the direction of or opposing the arrow X in FIG. 1, creates a bias force on the stiffness element 12. The biasing members, 14, 16 may be magnetically actuable members, arranged such that the biasing element 20 may be configured as a magneto-spring, as shown in FIG. 1.

The members 14, 16 may each be configured, for example, as a two-pole permanent magnet, such that the permanent magnets 14, 16 are oriented with like magnetic poles opposed to each other, creating a repulsive force therebetween, or, when the permanent magnets are oriented with dislike magnetic poles opposed to each other, creating an attractive force therebetween. The bias force provided by the two permanent magnets 14, 16 due to the change in the gap between them is a function of the number of poles and the strength of each pole. By suitably arranging these poles (two or more), a non-linear relationship of bias force vs. the gap between the magnets may be configured. As shown in FIG. 2, the magnets 14, 16 may each be generally configured as an annularly shaped magnet having a hollow center portion. The actuator 10 is configured such that the SMA element 12 passes through the hollow center of each annular magnet 14, 16, such that movement of the magnets 14, 16 relative to each other with respect to the axis of the SMA element 12 produces a bias force on the SMA element 12.

The biasing element 20 as configured may be actuated by displacing at least one of the permanent magnets 14, 16 from a position of neutrality or equilibrium with at least another of the permanent magnets 14, 16, thereby altering the magnetic field between the displaced magnets 14, 16 such that an attractive or repulsive force is created. The magnetic force (attractive or repulsive) created between the magnets 14, 16 may be proportional to and/or dependent on the relative magnitude and/or direction of displacement of one magnet from the other, the magnetic strength of each magnet, and the orientation of the magnetic poles of one magnet to the magnetic poles of the other magnet. The magnetic force (attractive or repulsive) resulting from displacement of one magnet from the other provides the bias force applied to the stiffness element 12. The input displacing one or more of the permanent magnets 14, 16 from another of the permanent magnets 14, 16 and thereby activating the biasing element 20 may be, for example, a change in length of the SMA element 12, or a displacement of the connection 28 and/or output interface 22. The change in magnetic force resulting from displacement of one magnet from the other may be non-linear to the amount of displacement, such that the bias force produced by the magneto-spring 20 comprising the permanent magnets is non-linear to the change in length of the stiffness element 12.

In another example, the biasing element 20 may be configured such that one of the biasing members 14, 16 may be a permanent magnet and the other of the biasing members 14, 16 may be an electromagnet. For the purpose of illustration, the permanent magnet shall be identified as element 14 in FIG. 1 and the electromagnet shall be identified as element 16. The electromagnet 16 may be configured such that strength of the magnetic field of the electromagnet 16 can be selectively manipulated (turned on/off, strengthened, weakened) by controlling and/or varying an electric current inputted to the coils of the electromagnet 16. The electromagnet 16 and the permanent magnet 14 may be configured, as discussed previously, to provide a biasing element 20 configured as a magneto spring, which may be a variable magneto-spring.

The biasing element 20 as configured may be actuated, for example, by displacing the permanent magnet 14 from the electromagnet 16 where the electromagnet 16 is held at a fixed magnetic strength, thereby altering the resultant magnetic field between the displaced magnets 14, 16 such that an attractive or repulsive force, depending on the relative direction of displacement, is created, as discussed previously for a biasing element 20 comprised of two permanent magnets. The input displacing the permanent magnet 14 from the electromagnet 16 and thereby activating the biasing element 20 may be, for example, a change in length of the SMA element 12, or a displacement of the connection 28 and/or output interface 22.

The biasing element 20 as configured with a permanent magnet 14 and an electromagnet 16 may be actuated, in another example, by manipulating or varying the electric current controlling the electromagnet 16, such that the strength of the magnetic field of the electromagnet 16 is changed, (either weakened or strengthened) relative to the constant or fixed magnetic field of the permanent magnet. The difference between the variable magnetic field of the electromagnet 16 and the fixed magnetic field of the permanent magnet 14 creates a resultant magnetic force (attractive or repulsive) between the electromagnet 16 and the permanent magnet 14, where the magnetic force provides a bias force applied to the stiffness element 12.

The input manipulating or varying the strength of the magnetic field of the electromagnet and thereby activating the biasing element 20 may be, for example, a change in electric current provided to the coils of the electromagnet 16 where the change in current is in response to an input from one or more sensors or switches, or to a controller which is responsive to at least one sensor, where the at least one sensor is sensing an operating characteristic of one or more of the stiffness element 12, the actuator 10, a device actuable by the actuator 10, and/or a system which may include the actuator 10, and where the at least one sensor is providing a signal to the stiffness element 12, switch or controller in response to changes in the operating characteristic or characteristics being sensed.

It would also be understood that the biasing element 20 as configured may be deactivated by terminating or ceasing the supply of an electric current to the electromagnet 16, such that there would be no bias force, or a bias force approximating zero, applied on the SMA element 12. Accordingly, for a biasing element 20 comprised of a permanent magnet 14 and an electromagnet 16, the magnetic force (attractive or repulsive) resulting from a displacement of one magnet from the other, the magnetic force resulting from a change in the strength of the magnetic field of the electromagnet 16 relative to the strength of the permanent magnet 14, and/or a combination of these magnetic forces, may provide the bias force applied to the stiffness element 12, which may be non-linear and/or variable, or in the instance where the electromagnet 16 is deactivated, a bias force approximating zero.

Other configurations of actuators including a biasing element are shown in FIGS. 2-7, where each of the actuators 30, 40, 50, 60, 70, 80 shown includes at least one magnetically actuable biasing element configured to apply a bias force on the stiffness element 12. By way of non-limiting example, actuator 30 includes a biasing element 32, actuator 40 includes a biasing element 42, actuator 50 includes biasing elements 20 and 42, actuator 60 includes a biasing element 52, actuator 70 includes a biasing element 62, and actuator 80 includes a biasing element 72.

The principles of operation of the biasing elements 20, 32, 42, 52, 62, 72 comprising the actuators 30, 40, 50, 60, 70, 80 have been generally described by the description of the operation of the various configurations of the biasing element 20 shown in FIG. 1. The operation of each non-limiting configuration will be described in further detail herein. It would be understood that each of the biasing elements 20, 32, 42, 52, 62, 72 are configured to include one or more biasing members, which may be magnetically actuated, and may be configured to be actuable to provide a non-linear and/or variable bias force on a stiffness element such as the SMA element 12 in response to an input, as discussed previously for the biasing element 20 shown in FIG. 1.

An actuator as described herein may include more than one biasing element, such that the biasing elements may be configured to act individually, in series, in parallel, or in a combination thereof to provide a bias force against the SMA element 12. For example, FIG. 4 shows an actuator 50, including a first biasing element 20 in parallel with the stiffness element 12, and a second biasing element 42 in series with both the first biasing element 20 and the stiffness element 12, wherein the biasing elements 20 and 42 may be selectively actuated individually or in combination with each other to apply a bias force on the stiffness element 12.

Referring now to FIG. 2, in a non-limiting example the actuator 30 includes a biasing element 32. The biasing element 32 may be configured to include one or more of a permanent magnet, an electromagnet or a MSMA, or other magnetically actuable member, or component such that the biasing element 32 is configured to be magnetically actuable. The biasing element 32 may be magnetically actuable by any means suitable to the magnetic biasing members comprising the biasing element 32. In the non-limiting example shown in FIG. 2, the biasing element 32 is comprised of a first biasing member 34 and a second biasing member 36, wherein at least one of the members 34, 36 is a magnetically actuable member. The first biasing member 34 may be operatively attached to the output interface 22 such that the biasing element 32 is in operative communication with the stiffness element 12. The second biasing member 36 maybe operatively attached to a support interface 18, such that the second biasing member 36 maybe held in a fixed position relative to a movable first biasing member 34.

As discussed for FIG. 1, the biasing members 34, 36 may each be configured as a permanent magnet, which may be for example, a two pole magnet. In the example shown in FIG. 2, the first permanent magnet 34 and the second permanent magnet 36 may each be generally configured as an annularly shaped magnet having a hollow center portion and which are arranged to be coaxial to each other and to the stiffness element 12. As discussed for actuator 10 of FIG. 1, the biasing members 34, 36 are oriented with like magnetic poles coaxially opposing each other, such that a repulsive force is created therebetween. The biasing element 32 as configured may be actuated by displacing at least one of the permanent magnets 34, 36, from a position of neutrality or equilibrium with at least another of the permanent magnets 34, 36, thereby altering the magnetic field between the displaced magnets 34, 36, such that an attractive or repulsive force is created. The magnetic force created between the magnets 34, 36 may be proportional to and/or dependent on the relative magnitude and/or direction of displacement of one magnet from the other, the magnetic strength of each magnet 34, 36, and the orientation of the magnetic poles of one magnet to the magnetic poles of the other magnet. The magnetic force resulting from displacement of one magnet from the other provides the bias force applied to the stiffness element 12. The input displacing one or more permanent magnets 34, 36 from the other end, thereby activating the biasing element 32 may be, for example, a change length of the SMA element 12, or displacement of the connection 28 and/or output interface 22. The change in magnetic force resulting from displacement of one magnet from the other may be non-linear to the amount of displacement, such that the bias force produced by the magneto spring 32 comprising the permanent magnets 34, 36 is non-linear to the change in length of the stiffness element 12.

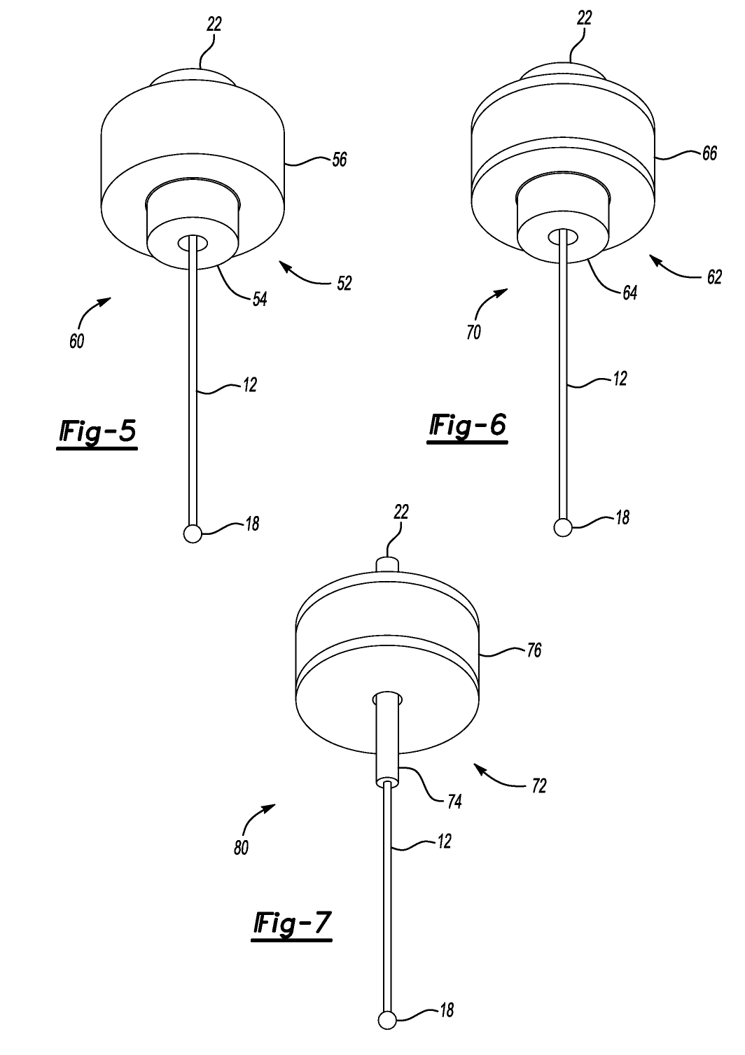

FIG. 5 shows an actuator 60, including a stiffness element 12 attached at a connection point 18 at one end and output interface 22 at the other end, wherein the biasing element 52 is comprised of two permanent magnets 54, 56. The two permanent magnets 54, 56 are arranged as described for FIG. 2. This arrangement can provide a constant bias force on the stiffness element 12 over a large stroke and in a minimal packaging space, thereby providing advantages over conventional stiffness members.

In another example the biasing element 32 shown in FIG. 2 may be configured such that one of the biasing elements 34, 36 may be a permanent magnet and the other biasing elements 34, 36 may be an electromagnet. For the purpose of illustration, the permanent magnet shall be identified as element 34 in FIG. 2 and electromagnet shall be identified as element 36. Electromagnet 36 may be configured, as previously discussed for FIG. 1, such that the strength of the magnetic field of the electromagnet 16 can be selectively manipulated by controlling and/or varying electric current provided to the coils of the electromagnet 36. The electromagnet 36 and the permanent magnet 34 may be configured, as previously discussed to provide a biasing element 32 configured as a magneto spring, which may be a variable magneto spring. The biasing element 32 thus configured with the permanent magnet 34 and electromagnet 36 may be actuated as discussed for FIG. 1, to provide a bias force on the SMA element 12.

FIG. 6 shows an actuator 70, including a stiffness element 12 attached at a connection point 18 at one end and output interface 22 at the other end, wherein the biasing element 62 is comprised of a permanent magnet 64, and an electromagnet 66. The permanent magnet 64 and the electromagnet 66 are arranged as described for FIG. 2. This arrangement can provide a tunable bias force on the stiffness element 12 in a minimal packaging space, by controlling the current supplied to the electromagnet, thereby providing advantages over conventional stiffness members.

Referring now to FIG. 3, shown is another non-limiting example of an actuator 40 configured as a tunable stiffness element. The actuator 40 includes a biasing element 42 configured in series with a stiffness element 12. Stiffness element 12 includes a smart material which may be, for example, an SMA material as discussed previously. The stiffness element 12 is operatively attached at one end to an input connection 18, and/or an input interface 24. The stiffness element 12 is operatively attached at the other end to a connection 28 and/or an intermediate interface 48. The biasing element 42 comprises a first biasing member 44 and a second biasing member 46. The first biasing member 44 maybe operatively connected to the output interface 22. Second biasing member 46 maybe operatively connected to the intermediate interface 48. Thus configured, the actuator 40 may provide an output to interface 22 in response to an input at input connection 18 and/or input interface 24 through the combination of the stiffness element 12 and the biasing element 42.

In one non-limiting example, the first biasing member 44 includes two permanent magnets, 44a, 44b, which are each configured as a permanent two-pole magnet. The two magnets, 44a, 44b, are placed with opposing poles (S-N) adjacent, such that the two magnets 44a, 44b, are attracted to each other. The biasing member 44 may be operatively connected to the output interface 22. The biasing element 46 includes two permanent magnets, 46a, 46b, which are each configured as a permanent two-pole magnet. The two magnets, 46a, 46b, are placed with opposing poles (S-N) adjacent, such that the two magnets 46a, 46b, are attracted to each other. The biasing member 44 and the biasing member 46 are oriented such that like poles (N-N) are aligned, providing a repulsive force between the biasing members 44, 46. By configuring each of the biasing members 44, 46, with more than one two-pole magnet, the magnetic field between the biasing members 44, 46 may be strengthened. Other configurations may be used. For example, each of the biasing members 44, 46 may be configured to include one two-pole magnet, rather than two, wherein a biasing element 42 so configured would provide a weaker magnetic field than the biasing element 42 configured as shown in FIG. 3. It would be understood that other configurations, wherein each of the biasing members 44, 46 may be configured to include a plurality of magnetic members, are possible.

The biasing element 42 configured as shown in FIG. 3 may be actuated as discussed for the biasing element 20 of FIG. 1, that is, by displacement of one of the biasing members 44 from the other of the biasing members 46 such that a magnetic force is created between the biasing members 44, 46 which acts as a biasing force on the SMA element 12, and in series with the SMA element 12 to provide an output force on the output interface 22. The input causing the displacement of one of the biasing members 44, 46 may be, for example, a change in the length of the SMA element 12, when the SMA element 12 is actuated, or may be for example, a displacement of the output interface 22.

Referring again to FIG. 3, it would be understood that one of the biasing members 44, 46 may be replaced with electromagnet, which may be actuated as previously discussed for FIGS. 1 and 2, to provide another configuration of a biasing element 42.

Other configurations of a biasing element in series with a stiffness element 12 may be used. In a non-limiting example, FIG. 7 shows a biasing element 80, which may be comprised of a magnetic shape memory alloy (MSMA) member 74, and a source of a magnetic field to actuate the MSMA 76. The MSMA may also be referred to as a ferromagnetic shape memory alloy (FSMA), and may include any ferromagnetic material which may exhibit large changes in shape and size under the influence of an applied magnetic field due to changes in the martensitic structure of the MSMA. The MSMA may be, for example, a nickel-manganese-gallium (Ni—Mn—Ga) alloy. The source of a magnetic field to actuate the MSMA, e.g., to cause changes in the martensitic structure of the MSMA, may be configured as an electromagnet 76. The electromagnet 76 may be configured such that strength and the direction of the magnetic field of the electromagnet 76 can be selectively manipulated by controlling and/or varying an electric current provided to the coils of the electromagnet 76, to provide a magnetic field of sufficient strength and in the direction required to actuate the MSMA member 74, e.g., to cause a rearrangement of the martensitic twin structure of the MSMA, thereby causing a change in biasing dimension of the MSMA member 74, for example, an increase in the length of the MSMA member 74 aligned with the direction of the applied magnetic field. A reduction in the strength or reversal in the direction of the magnetic field may reverse the rearrangement of the martensitic twin structure, thereby causing a reversal of the change in the biasing dimension of the MSMA member 74, e.g., in the present example, a reduction in the length of the MSMA member 74 to a deactuated length. The change in the length of biasing dimension of the MSMA member 74 under the influence of an applied magnetic field may be referred to herein as the magnetic shape memory effect (MSME).

As shown in FIG. 7, the actuator 80 includes the stiffness element 12, which may be an SMA element, operatively attached at one end to an input connection 18, and at the other end to the MSMA element 74, such that the SMA element 12 and the MSMA element 74 are connected in series to the output interface 22. When a magnetic field is provided by the electromagnet 76 and applied to the MSMA member 74 at sufficient strength and in the direction required to induce the magnetic shape memory effect (MSME), the biasing dimension, e.g., the length of the MSMA member 74 increases due to the MSME such that the MSMA member 74 applies a biasing force on the stiffness element 12 to which it is operatively connected. When the MSME is reversed, for example, by reversing the direction of the applied magnetic field provided by the electromagnet 76, the MSMA of the MSMA member 74 is deactuated, e.g., the changes to the martensitic structure are reversed to cause a shortening in the biasing dimension, e.g., the length of the MSMA member 74, and the bias force applied to the SMA element 12 is reversed. The input varying the strength and direction of the magnetic field of the electromagnet 76 and thereby activating the MSME of the MSMA member 74 of the biasing element 80 may be, for example, a change in electric current provided to the coils of the electromagnet 76 where the change in current is in response to an input from one or more sensors or switches, or to a controller which is responsive to at least one sensor, where the at least one sensor is sensing an operating characteristic of at least one of the actuator 10, the stiffness element 12, a device actuable by the actuator 10, and/or a system which may include the actuator 10, and where the at least one sensor is providing a signal to the stiffness element 12, switch or controller in response to changes in the operating characteristic or characteristics being sensed. Accordingly, for a biasing element 80 comprised of a MSMA member 74 and an electromagnet 76, the MSME and associated change in the biasing dimension of the MSMA member 74 may provide the bias force applied to the stiffness element 12, which may be variable depending on the strength of the magnetic field and the magnitude and extent of the change of the martensitic structure of the MSMA member 74 which is activated by the MSME. The actuator 80 may be used, for example, to compensate for slack in the SMA element 12, by controlling the current supplied to the electromagnet 76 activating the MSMA member 74. As such, the actuator 80 may be used to electronically adjust pre-compression in a conventional bias spring system, when configured in conjunction with such a system, during initial set-up or configuration of the system, or during the useful life of the system, to compensate for system component wear or deterioration, changes in system operating environment or conditions, or other changes in system performance.

Referring now to FIG. 4, shown is a schematic illustration of an actuator 50 including an SMA stiffness element 12 and a plurality of magnetic biasing elements 20, 42. The biasing element 20 is configured in parallel with the stiffness element 12, and the biasing element 42 is configured in series with the SMA stiffness element 12 and the biasing element 20. The biasing elements 20, 42, may be of any configuration comprising at least one magnetically actuable biasing member, as previously discussed for FIGS. 1, 2 and 3. The biasing elements 20, 42 maybe activated individually and/or in combination to provide a bias force on the stiffness element 12 which may be variable and dynamic depending on the combination, magnitude and sequence of activation of the biasing elements 20, 42.

Other actuator configurations including a plurality of stiffness elements, wherein at least one of the plurality of stiffness elements includes a smart material, and a plurality of biasing elements, wherein at least one of the plurality of the biasing elements is magnetically actuated, are possible. It would be understood that each of the plurality of biasing elements may be one of actuable in series with at least one of the plurality of stiffness elements, actuable in parallel with at least one of the plurality of stiffness elements, or actuable in a combination of parallel and series with each other and one or more of the plurality of stiffness elements, such that the plurality of biasing elements are configured to provide a bias force on the plurality of stiffness elements, individually or in combination.

An input to an actuator such as the actuators 10, 30, 40, 50, 70, 80, wherein at least one of the biasing elements may be electromagnet or other electrically actuated biasing member, may be configured as an electrical current, which may activate the electromagnet or biasing member to provide a variable bias force using the biasing element. The actuator may be controlled by a controller (not shown) configured to provide the input to control the output of the actuator, where the input may be defined by at least one of the output of the actuator, the output of the stiffness element, the output of a device actuated by the actuator, or the output of a system including the actuator. The controller may be configured to provide an actuating input to one or both of the stiffness element in the biasing element of the actuator, wherein the input may be the same input or different inputs. The controller may include control logic, such that the input to the stiffness element in the input to the biasing element is coordinated to provide a desired stiffness output from the actuator. The controller may actuate the stiffness element and the bias element concurrently, sequentially, or in another pattern or sequence to provide the desired stiffness control output from the actuator. The stiffness control output from the actuator may be variable based on the pattern of actuation of the stiffness element in the biasing element to provide for variable actuation of an actuable device operatively connected to the actuator. The input may be defined by one or more of fatigue, functional degradation, aging, shakedown, elongation, and operating environment of the smart material of the stiffness element 12 of the actuator. The input may be defined by an operating characteristic or the operating environment, for example, the temperature or humidity of actuator environment, monitored, for example, by a sensor and/or the controller.

The biasing element or elements of an actuator may be actuated sequentially or concurrently and/or in combination with actuation of the stiffness element 12 to provide a variable bias force on the stiffness element, and/or variable output from the actuator. The ability to configure an actuator with a combination of one or more smart stiffness elements in combination (parallel, series or combination thereof) with one or more biasing elements, where at least one of the biasing elements is magnetically actuable provides an advantage over conventional stiffness actuators, including those configured with the smart stiffness element and a conventional, e.g., mechanical, bias spring. Additionally, the use of magnetically actuable biasing elements provides advantages of tunability, compact packaging, robustness, variable actuation, and friction compensation, when compared with a conventional stiffness actuator.

A method for providing tunable stiffness control may be provided, including configuring an actuator, such as any of the actuators shown in FIGS. 1-7 to provide a stiffness output via an output connection 28 and/or an output interface 22. The method further includes actuating the smart material element and selectively actuating the biasing element to provide the actuator stiffness control output.

The system may be provided, including a variable stiffness control device, such as any of the actuator shown in FIGS. 1-7. It would be understood that the system may also be configured to sense change in the output range of at least one of the stiffness element, the actuator, and/or the actuable device, where the change may be caused by or result from, for example, deterioration of one or more of the stiffness element, the actuator, and/or the actuable device. Changes in the output range of the stiffness element or the actuable device may be detected, for example, by sensing a change in the activated and deactivated length of the stiffness element affecting or modifying the output of the actuator, or by sensing the change in the performance characteristics of the actuated device, which may be, for example, a measure of displacement or force output. The stiffness element may change, e.g., may deteriorate or become degraded, due to repeated use or in-service loads which may be designed or incidental loads, repeated actuations at high temperatures or high loads, or other factors affecting stiffness element performance, durability and reliability. The change or deterioration in stiffness element performance may be caused by, for example, by aging, fatigue, shakedown, functional degradation, and/or elongation of the stiffness element material after repeated actuation. The actuated device may change, e.g., may deteriorate or become degraded due to repeated use or in-surface floats, repeated actuations, or other factors affecting the performance, durability, and reliability of the device actuated by the actuator.

The controller and actuator may be configured to adjust or modify the activation sequence or the combination of the plurality of stiffness elements and/or biasing elements activated, or the individual stiffness element and/or biasing element activated to provide an actuator output and/or actuated device output which compensates for the deterioration in or other changes in the output of one or more of the plurality of stiffness elements, or other changes in the output of the actuator device, to provide an equivalent output, e.g., a functionally substitutional output, for the output provided prior to the deterioration or other change. Similarly, the controller and/or actuator may be additionally configured to adjust the activation or modify the activation sequence or the combination of the plurality of stiffness elements activated, or the individual stiffness element to provide an output which compensates for other system changes, such as wear or deterioration of the actuated device or element, changes in operating environment such as changes in the ambient temperature or humidity in which the actuated device and/or the actuator are operated, etc., which require a modification in the actuator output to provide the required operating condition of the actuated device.

By configuring an actuator with a plurality of actuable stiffness elements and a plurality of biasing elements in parallel, in series, or in a combination thereof, with an actuable device (via the connection 28, and/or output interface 22), an actuable stiffness element and/or biasing element or a plurality of actuable stiffness elements and/or biasing elements may be activated and deactivated individually, in combination, at various times, in various sequences, and/or at various magnitudes, strengths, and or displacements of the biasing element or elements, to provide a specific and refined response to input conditions, which may be a variable and/or nonlinear response, therefore enhancing the capability to respond to multiple variables and a broader scope of inputs.

Other configurations of the actuator and system described herein are possible. For example, an actuator may include any number of SMA elements configured in various shapes and defined by various force/stress and stroke/strain output curves and stiffness characteristics. Further, the SMA elements may be defined in any combination of series and parallel configurations as required to provide the actuation output desired for the actuator and/or operation of the actuated device. The tunable stiffness actuators discussed herein may comprise other configurations of SMA material such as SMA ribbon, SMA film, SMA cable, SMA embedded composite materials, and configurations formed from SMA bulk materials such as SMA powder metal.

The biasing elements discussed herein may comprise other configurations of magnetically actuable members, as previously discussed, including electromagnets and magnetically actuable MSMA members. The biasing elements may be configured to include biasing members of various shapes, sizes, magnetic strengths, and arrangements, such as are required to provide the biasing force for a particular configuration of a tunable stiffness actuator, as may be required to actuate a device or system, or for particular application. In addition to the advantages previously discussed, the system and apparatus provided herein can accommodate rapid changes in stiffness, for example, within a few milliseconds, using the ability to rapidly actuate and deactuate one or more of the stiffness element or elements and/or the biasing element or elements of a given actuator.

While the best modes for carrying out the invention have been described in detail, those familiar with the art to which this invention relates will recognize various alternative designs and embodiments for practicing the invention within the scope of the appended claims.

1. An actuator adaptable for tunable stiffness control, the actuator comprising:
a stiffness element including a smart material; and
a biasing element configured to be magnetically actuated;
wherein the biasing element is magnetically actuated to provide a bias force on the stiffness element.

2. The actuator of claim 1, wherein the smart material is a shape memory alloy.

3. The actuator of claim 1, wherein the stiffness element and the biasing element are configured in parallel with each other.

4. The actuator of claim 1, wherein the stiffness element and the biasing element are configured in series with each other.

5. The actuator of claim 1, further comprising:
a plurality of stiffness elements, wherein at least one of the plurality of stiffness elements includes a smart material;
a plurality of biasing elements, wherein at least one of the plurality of the biasing elements is magnetically actuated;
wherein each of the plurality of biasing elements are one of:
actuable in series with at least one of the plurality of stiffness elements,
actuable in parallel with at least one of the plurality of stiffness elements, and
actuable in a combination of parallel and series with each other and one or more of the plurality of stiffness elements,
such that the plurality of biasing elements provide a bias force on the plurality of stiffness elements.

6. The actuator of claim 1, further comprising:
a plurality of stiffness elements, wherein at least one of the plurality of stiffness elements includes a smart material;
a plurality of biasing elements, wherein at least one of the plurality of the biasing elements is magnetically actuated;
wherein at least one of the plurality of biasing elements is configured to provide a variable bias force on at least one of the plurality of stiffness elements.

7. The actuator of claim 1, wherein the bias force is non-linear.

8. The actuator of claim 1, wherein the biasing element is configured to include a permanent magnet.

9. The actuator of claim 1, wherein the biasing element is configured to provide a variable bias force in response to an input.

10. The actuator of claim 9, wherein the biasing element is configured to include a magnetic shape memory alloy.

11. The actuator of claim 9,
wherein the biasing element is configured to include an electromagnet; and
wherein the input is configured as an electrical current.

12. The actuator of claim 9, wherein the input is defined by one or more of fatigue, functional degradation, aging, shakedown, elongation, and operating environment of the smart material of the stiffness element.

13. The actuator of claim 9, further including a controller controlling the actuator and a device actuated by the actuator;
wherein the controller is configured to provide the input; and
wherein the input is defined by one or more outputs from at least one of the actuator and the actuated device.

14. The actuator of claim 9, further comprising a system including the actuator and an actuated device, wherein the input is defined by a change in one of:
a system output,
a system operating characteristic,
an operating characteristic of the actuated device, and
an operating condition of one of the system, the actuated device, and the actuator.

15. A method for providing tunable stiffness control, the method comprising:
configuring an actuator to provide a stiffness control output, the actuator including:
a stiffness element including an actuable smart material, and
a biasing element configured to be magnetically actuated to provide a variable bias force;
actuating the smart material and selectively actuating the biasing element to provide the stiffness control output.

16. The method of claim 15, wherein the biasing element is configured to include an electromagnet, and wherein selectively actuating the biasing element includes providing an electrical current to the electromagnet.

17. The method of claim 15,
wherein the actuator includes a plurality of biasing elements, wherein at least one of the plurality of biasing elements is magnetically actuated;
wherein each of the plurality of biasing elements are configured as one of:
in parallel with the stiffness element, and
in series with the stiffness element; and
selectively actuating one or more of the plurality of biasing elements to provide a variable bias force to the stiffness element.

18. A tunable stiffness control system comprising:
a device configured to be actuated by an actuator output;
an actuator including:
a stiffness element including a shape memory alloy, and
a biasing element configured to be magnetically actuated to provide a variable bias force on the stiffness element;
wherein the actuator is configured to provide the actuator output.

19. The system of claim 18, wherein the biasing element includes an electromagnet, wherein the electromagnet is selectively actuated by an electrical signal.

20. The system of claim 18, further comprising:
a controller configured to control the system, wherein the controller selectively actuates the biasing element in response to an operating characteristic defined by the device.
